(19) United States
(12) Patent Application Publication
(10) Pub. No.: US 2026/0044737 A1
(43) Pub. Date: Feb. 12, 2026

(54) DEVICE AND METHOD FOR ONE-SHOT NEURAL ARCHITECTURE SEARCH WITH UNLABELED DATA

(71) Applicant: Robert Bosch GmbH, Stuttgart (DE)

(72) Inventors: Martin Rapp, Esslingen Am Neckar (DE); Attila Reiss, Rutesheim (DE); Benedikt Sebastian Staffler, Tuebingen (DE)

(21) Appl. No.: 19/289,192

(22) Filed: Aug. 4, 2025

(30) Foreign Application Priority Data
Aug. 9, 2024 (DE) 10 2024 207 608.2

(51) Int. Cl. G06N 3/082; G06V 10/764; G06V 10/774; G06V 10/82

(52) U.S. Cl. CPC G06N 3/082; G06V 10/764; G06V 10/774; G06V 10/82

(57) ABSTRACT

A computer-implemented method of neural architecture search. The method includes: training a supermodel by sampling an architecture and training the supermodel with the sampled architecture on labeled training data and updating weights of the supermodel by gradients with respect to the sampled models; determining Pareto-optimal submodels of the supermodel based on at least two performance metrics by iteratively carrying out the following steps: computing outputs of a reference model for the unlabeled data, wherein the reference model a largest submodel of the supermodel; sampling a plurality of submodels from the supermodel; computing by the submodels their outputs of the unlabeled data; computing a difference between the outputs of the reference model and the submodels; employing an optimization algorithm to iteratively sample and evaluate submodels based on a plurality of objectives.

### CROSS REFERENCE

The present application claims the benefit under 35 U.S.C. § 119 of Germany Patent Application No. DE 10 2024 207 608.2 filed on Aug. 9, 2024, which is expressly incorporated herein by reference in its entirety.

### FIELD

The present invention relates to a method for one-shot neural architecture search comprising a two-stage procedure, a computer program, and a machine-readable storage medium and a system.

### BACKGROUND INFORMATION

Neural architecture search (NAS) techniques face the problem that compared to classical supervised learning, the available data not only is used for 1) training the model weights (training data), and 2) validation of the model to estimate its performance on unseen data (validation data), but additionally 3) determine the optimal model architecture (search data). The validation data must not be used for search because that would not allow an unbiased estimation of the model performance anymore. Therefore, existing techniques use the training data also for search.

Ideally, training and search data are independent to allow unbiased rating of architectures (and acquire robustness to potential overfitting to the training data). Techniques such as SPOS (Zichao Guo, Xiangyu Zhang, Haoyuan Mu, Wen Heng, Zechun Liu, Yichen Wei, Jian Sun. “Single Path One-Shot Neural Architecture Search with Uniform Sampling”. EECV. 2020. doi.org/10.1007/978-3-030-58517-4_32) follow this intuition and split the original training data into two distinct parts for training and search.

The problem with such an approach is that fewer data are available for model training, reducing the quality of trained models, and thereby increasing the variance in performance estimations. Such approaches are, therefore, only applicable to scenarios where sufficient training data are available (e.g. >50k labeled examples).

Other techniques, such as BigNAS (Jiahui Yu, Pengchong Jin, Hanxiao Liu, Gabriel Bender, Pieter-Jan Kindermans, Mingxing Tan, Thomas Huang, Xiaodan Song, Ruoming Pang, Quoc Le. “BigNAS: Scaling up Neural Architecture Search with Big Single-Stage Models”. ECCV. 2020. doi.org/10.1007/978-3-030-58571-6_41) or NASViT (Chengyue Gong, Dilin Wang, Meng Li, Xinlei Chen, Zhicheng Yan, Yuandong Tian, qiang liu, Vikas Chandra. “NASViT: Neural Architecture Search for Efficient Vision Transformers with Gradient Conflict aware Supernet Training”) use the full original training data for model training, and use parts or the full training data also for architecture search, i.e., there is an overlap between training and search data. While this improves the training quality, the search data has been used during training, and, hence, does not offer an unbiased estimation of the performance on unseen data. That means, such approaches are also only applicable in scenarios where sufficient training data are available to reduce the risk of overfitting.

Finally, there have been attempts to perform NAS without any labeled data, e.g., Chenxi Liu, Piotr Dollár, Kaiming He, Ross Girshick, Alan Yuille, Saining Xie. “Are Labels Necessary for Neural Architecture Search?”. ECCV. 2020. dx.doi.org/10.1007/978-3-030-58548-8_46. These techniques perform NAS on an unlabeled proxy task, e.g., rotation prediction or recolorization, and transfer the found architecture to the actual task. Such methods, while not requiring labeled data for NAS, suffer from lower quality of the found architectures because the correlation between performance of an architecture on the proxy task and the actual task may be low.

### SUMMARY

This present invention tackles the problem of one-shot NAS with little available labeled data. The present invention reserves the full labeled training data for training to maximize the quality of the trained one-shot model (supermodel) and use unlabeled data for architecture search. In particular, according to an example embodiment of the present invention, it is provided to evaluate the performance of a certain subnetwork of one-shot model by comparing its output on unlabeled data to the output of a reference network.

The unlabeled data could be from the same application, similar data from a related application, or synthetic data. The selection of the reference network is important as its performance should be higher than the performance of the subnetwork to be able to produce high-quality reference output. Also, creating it should not impose additional training overhead to the already computationally-demanding NAS procedure. The present invention tackles these challenges by using the biggest subnetwork in the one-shot model as the reference network, as it 1) typically has the highest performance among all subnetworks (in particular when specific training techniques such as the sandwich rule and in-place distillation are used), and 2) is already available.

In summary, one task of the present invention is to provide one-shot NAS with little available labeled data, wherein the present invention effectively solves it by estimate the performance of subnetworks of the one-shot model in one-shot NAS by comparing their output on unlabeled search data to the output of the largest submodel in the one-shot model.

The related art discussed above cannot efficiently use limited available training data for one-shot NAS. In contrast, the present invention utilizes the full labeled training data for model training that improves the quality of the trained supermodel. This reduces the variance in estimations of the performance of submodels, leading to better found architectures. Furthermore, the present invention maintains independence between training and search data enabling unbiased estimation of the performance of submodels, also leading to better found architectures. Furthermore, by avoiding a proxy task for NAS, and searching on the actual task alleviates issues due to low correlation between proxy task and actual task, and thereby leads to better found architectures.

In addition, by using an already existing submodel (e.g., the largest submodel) as a reference model, the present invention does not require training and maintaining an extra reference model. Thereby, computational complexity and engineering effort is reduced further.

In a first aspect of the present invention, a method of neural architecture search is provided in particular for training a classifier for classifying input signals obtained from a sensor. The method starts with a training of a supermodel with multiple searchable dimensions by sampling an architecture within the searchable dimension and training the supermodel with the sampled architecture on labeled training data and updating weights of the supermodel by gradients with respect to the sampled models. The supermodel can be a large neural network. The supermodel can be a large neural network, where submodels of this network form valid architectures with reduced complexity. Examples include fewer channels, fewer layers, smaller embedding sizes, etc.

After the training, a step of determining Pareto-optimal submodels of the supermodel based on at least two performance metrics is iteratively carried out.

The determining of Pareto-optimal submodels starts with computing outputs of a reference model for the unlabeled data, wherein the reference model is a largest submodel of the supermodel. The performance metrics can be an accuracy of the respective submodel and hardware latency of the respective submodel on a given computation unit or device. Other hardware related performance metrics can comprise latency, FLOPS, power consumption and/or memory usage. Preferably, said performance metrics for the reference model are not computed, instead only model outputs are computed (e.g., classes, object bounding boxes, etc.), which are then merely compared with each other.

Then, a plurality of submodels are sampled from the supermodel. Then, the submodels compute their outputs of the unlabeled data, also referred to as propagating the unlabeled data through the submodels. Then, a difference between the outputs of the reference model and the submodels are determined. Finally, an optimization algorithm is applied to iteratively sample and evaluate further submodels based on a plurality of objectives, wherein the objectives comprise the difference between the outputs of the reference model and the submodels and other performance metrics. Examples for other performance metrics comprise latency, FLOPS, power consumption and/or memory usage. By iteratively applying the optimization algorithm, the sampled submodels converge towards the Pareto-optimal submodels for said objectives.

In further aspects of the present invention, it is envisioned that the supermodel and thus the submodels are classifier trained to classify input signals. The classifier can be used by receiving a sensor signal comprising data from a sensor, determining an input signal which depends on said sensor signal, and feeding said input signal into said classifier to obtain an output signal that characterizes a classification of said input signal.

Such classifiers may then be used for providing an actuator control signal for controlling an actuator, comprising all the steps of the above method and further comprising the step of determining said actuator control signal depending on said output signal. Preferably said actuator controls an at least partially autonomous robot and/or a manufacturing machine and/or an access control system.

The sensor may determine measurements of the environment in the form of sensor signals, which may be given by, e.g. digital images, e.g. video, radar, LiDAR, ultrasonic, motion, thermal images or audio signals.

Preferably, the present invention can be used for classifying the sensor data, detecting the presence of objects in the sensor data or performing a semantic segmentation on the sensor data, e.g., regarding traffic signs, road surfaces, pedestrians, vehicles.

The supermodel and submodels can be used for determining a continuous value or multiple continuous values, i.e., perform a regression analysis, e.g., regarding a distance, a velocity, an acceleration, tracking an item, e.g., an object, in the data. This is carried out based on low-level features (e.g. edges or pixel attributes for images).

The present invention can be used to compute a control signal for controlling a technical system, like e.g. a computer-controlled machine, like a robotic system, a vehicle, a domestic appliance, a power tool, a manufacturing machine, a personal assistant or an access control system.

Example embodiments of the present invention will be discussed with reference to the following figures in more detail.

### BRIEF DESCRIPTION OF THE DRAWINGS

FIG. 1 shows a schematic architecture of a supermodel and sampled submodels from the supermodel.

FIG. 2 shows a schematic flow diagram of an example embodiment of the present invention.

FIG. 3 shows a control system controlling an at least partially autonomous robot, according to an example embodiment of the present invention.

FIG. 4 shows a control system controlling a manufacturing machine, according to an example embodiment of the present invention.

FIG. 5 shows a control system controlling an access control system, according to an example embodiment of the present invention.

FIG. 6 shows a control system controlling a surveillance system, according to an example embodiment of the present invention.

FIG. 7 shows a control system controlling an automated personal assistant, according to an example embodiment of the present invention.

FIG. 8 shows a control system controlling an imaging system, according to an example embodiment of the present invention.

FIG. 9 shows a training system for controlling the classifier, according to an example embodiment of the present invention.

### DETAILED DESCRIPTION OF EXAMPLE EMBODIMENTS

The present invention improves the search procedure of two-stage neural architecture search. In general, two-stage NAS comprises the two stages as follows:
1) Supermodel training. This is a neural network model, where several dimensions of the model are searchable, i.e., not fixed during supermodel training. Typical searchable dimensions can be the number of layers in different parts of the network, the number of channels, kernel sizes, group sizes in grouped convolutions, embedding dimensions, number of attention heads, MLP ratios, etc.

A supermodel allows for extraction of submodels that make specific architecture choices for the searchable dimensions.

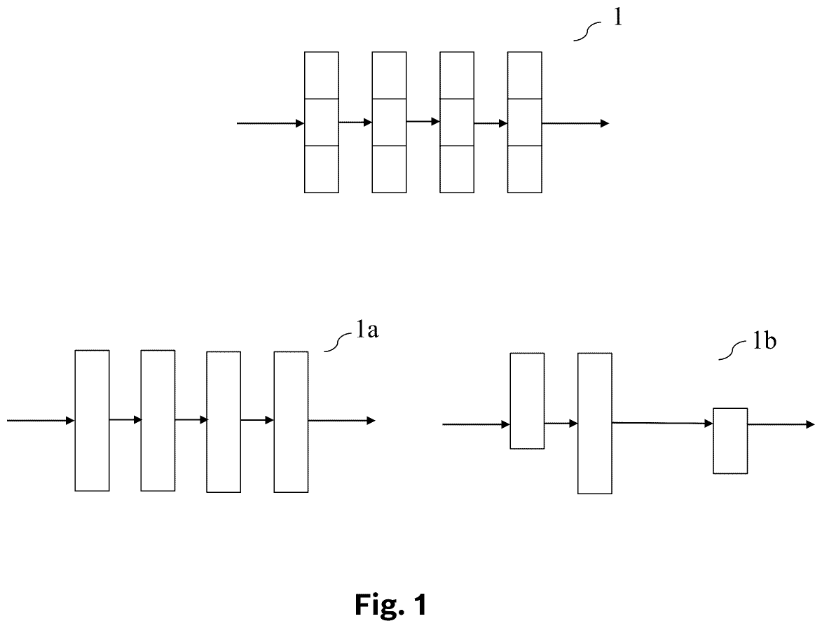

The largest submodel uses the maximal values for each searchable dimension. See FIG. 1 for an illustration of a supermodel 1 and the largest submodel 1a. The training procedure typically happens by sampling one or several architectures from the one-shot model in each update step, calculate the gradient w.r.t. the sampled models and use this to update the weights of the supermodel. Conventional approaches of the related art, e.g., sample a single random model. However, the inventors suppose that the present invention works particularly well with the sandwich rule from Yu, J., & Huang, T. S. “Universally slimmable networks and improved training techniques”. ICCV. 2019. doi.org/10.48550/arXiv.1903.05134, which samples two random architecture as well as the smallest and largest architecture in each update iteration and thus, typically leads to the largest model being the best model in the search space.

Furthermore, techniques like in-place distillation (described in a previous publication) further encourage smaller submodels to be similar to the largest one.

After the first stage has been terminated, the second stage starts:
2) Architecture search. This stage identifies submodels of the supermodel that are Pareto-optimal w.r.t. the objectives (e.g., accuracy and/or hardware latency and/or other objectives). This is typically done by iteratively selecting submodels and evaluating them. Importantly, this step does not require any model training, as the trainable weights of the submodel are taken from the corresponding parts of the trainable weights of the supermodel.

Employing optimization algorithms like evolutionary search improves the search efficiency. Evaluating submodels comprises e.g., to measure accuracy (using search data), latency, etc.

The process on how to iteratively select submodels for evaluation in order to find the “good” ones (i.e., Pareto-optimal ones) can be carried out by an evolutionary optimization, where new submodels are created by random mutations (e.g., change the number of filters in a certain part of the network, or change the depth) of already evaluated submodels. The idea is that evolutionary optimization continues the search in the vicinity of the best-so-far submodels. Another option would be to use black-box-optimization methods like Bayesian optimization (BO).

The main benefit of this invention is to use unlabeled data for the architecture search stage of two-stage NAS. This leaves more data available for the first stage, i.e., supermodel training, and at the same time maintains independence between training and search data. This is achieved with the following steps to approximate the application performance (e.g., accuracy, IoU) of submodels by computing the difference of their output to the output of the largest submodel, depicted in FIG. 1 by reference 1a. The largest submodel can be given by all searchable dimensions are maximal.

Given trained supermodel M and unlabeled search data D, a pseudo code is given as follows:
1) (optional) filter search data D: D′=f_{filt}(D)
2) Compute output of biggest submodel A_{big}:y_{big}=M(D,A_{big})
3) For each submodel A:
a) Compute output of submodel A: y_{A}=M(D′,A)
b) Compute output difference

$$L = {f}_{s i m} ( y , {y}_{b i g}^{′} )$$

Finally, the difference L can be used as a search objective (e.g. minimize L).

The unlabeled search data D can be provided from several potential sources. Unlabeled data can be collected from the same application. This may be the case if only a fraction of the available data has been labeled. Additionally or alternatively, unlabeled data can be collected from a related application, e.g.: data from a previous product generation, e.g. taken with a different camera model. Additionally or alternatively, synthetic data can be used as unlabeled data that has been generated from the training data distribution. The selection of the unlabeled data can be pivotal, as it required to make a trade-off between the amount of available data, and the similarity to the actual application. The amount of data should be sufficient to obtain low-variance estimates of the submodel performance. Preferably, low-variance estimates require e.g. at least 100 input samples, having 1k-10k would be ideal. At the same time, if the unlabeled data is too dissimilar to the application, it may not be indicative of the true submodel performance.

If the domain of the unlabeled data is much broader than that of the training data, for example: training data are road scenes, unlabeled data are images from the internet), the output y_{big} of the largest submodel 1a may not be useful. In this case, D and, correspondingly, y_{big} should be filtered.

However, if the domain of the training data and unlabeled search data are similar, no filtering is required. Therefore, there are several options on how to filter search data with f_{filt}. The trivial filter option can be a no filter: D′=D. For image classification, the filter operation can be defined by selecting images with high confidence: D′={d|max(M(d,A_{big}))>δ,d∈D}.

For the step 3b) above, the difference can be computed as follows: a first option for the difference is a Kullback-Leibler divergence:

$$L = \frac{1}{\vert Y \vert} {\sum }_{( {y}_{big} , y ) ∈ ( {Y}_{big} , Y )} {\sum }_{j} {y}_{b i g}^{j} log ( \frac{{y}_{b i g}^{j}}{{y}^{j}} ) ) ,$$

a second option is a mean-squared error:

$$L = \frac{1}{\vert Y \vert} {\sum }_{( {y}_{b i g} , y ) ∈ ( {Y}_{big} , Y )} {\sum }_{j} {( {y}_{b i g}^{j} - {y}^{j} )}^{2} ,$$

a third option are hard labels:

$$L = \frac{1}{\vert Y \vert} {\sum }_{( {y}_{b i g} , y ) ∈ ( {Y}_{big} , Y )} : max ( {y}_{big} ) \neq max ( y ) .$$

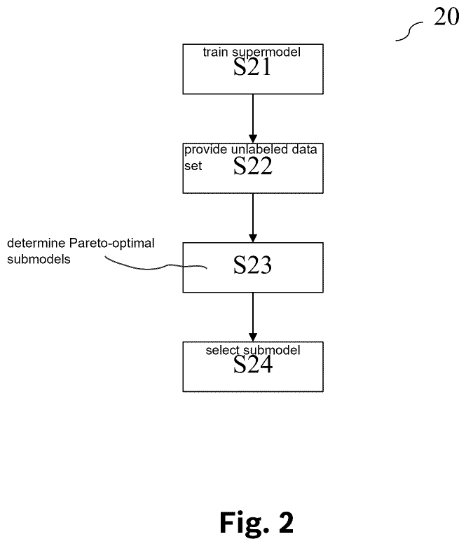

FIG. 2 shows a flow chart 20 of an embodiment of the present invention. The described method in FIG. 2 is a sophisticated approach to neural architecture search (NAS), a crucial aspect of machine learning that focuses on automating the design of artificial neural network architectures. The method of FIG. 2 aims to optimize the process of identifying the most efficient and effective neural network architectures from a vast search space effectively defined within a supermodel (1). The method is detailed in several key steps, each contributing to the overall goal of finding Pareto-optimal submodels that balance between performance metrics such as accuracy and hardware metric such as latency.

The method starts with a training (S21) of the supermodel 1. This supermodel acts as the foundation from which specific architectures (submodels) can be sampled and evaluated. The training (S21) can comprise several steps. It starts with an architecture sampling. Within the supermodel's defined searchable dimensions, individual architectures are sampled. These dimensions could include aspects like the number of layers, types of layers (convolutional, recurrent, etc.), and layer sizes. In the second step, a training with labeled training data is carried out. Each sampled architecture is trained using a dataset of labeled training data. After the training of the sampled architectures, a weight updating of the supermodel is carried out. The weights of the supermodel are updated based on gradients calculated with respect to the performance of the sampled architectures. This step ensures that the supermodel learns from each architecture's performance, gradually improving its ability to generate effective submodels.

After training (S21), an unlabeled data set is provided (S22). The unlabeled data set can be smaller than the labeled training data set of step S21. This unlabeled data is crucial for assessing the submodels' performance in a way that is independent of expensive labels, offering insights into how well the submodels performs.

Afterwards, the Pareto-optimal submodels are determined (S23), which are submodels that offer the best trade-off between at least two performance metrics, such as accuracy and hardware latency, making them Pareto-optimal choices for specific applications.

The step S23 starts with selecting a reference model. Preferably, the reference model is the largest submodel (1a). It would be possible to use any other network as reference model that has been trained on the same task, but this would compromise on one of the main advantages of this invention—no additional cost to create the reference model. The outputs for the unlabeled data are computed using a reference model. This reference model shall provide a benchmark for comparison. Then, a plurality of submodels (1b) are sampled from the supermodel (1). A variety of submodels (1b) are preferably randomly sampled from the supermodel, each representing a different architecture within the search space. Then, outputs are calculated for the submodels. Each sampled submodel computes outputs for the same unlabeled data. Then, a difference

$$L = {f}_{s i m} ( y , {y}_{big}^{′} )$$

between the outputs of the reference model and those of the submodels are calculated. These differences characterize how closely each submodel approximates the behavior of the reference model. Based on these differences, an optimization algorithm is employed to iteratively sample and evaluate submodels. Preferably, the optimization algorithm is applied with respect to a plurality of objectives including the computed differences, and their performance metrics. The algorithm seeks to find submodels that strike the best balance according to these objectives. After the optimization algorithm is converged, the submodels that are determined to be Pareto-optimal based on the objectives, with a particular emphasis on balancing accuracy and hardware latency, are selected and outputted. These submodels represent the most efficient and effective architectures identified through the search process.

After step S23 is terminated, a submodel of the Pareto-optimal submodels is selected (S24) for deployment on a target device based on e.g. user predefined criterion of a specific application that should be carried out on the target device.

The selected submodel according to step S24 can be an image classifier (60) and preferably applied as described in the following for different applications.

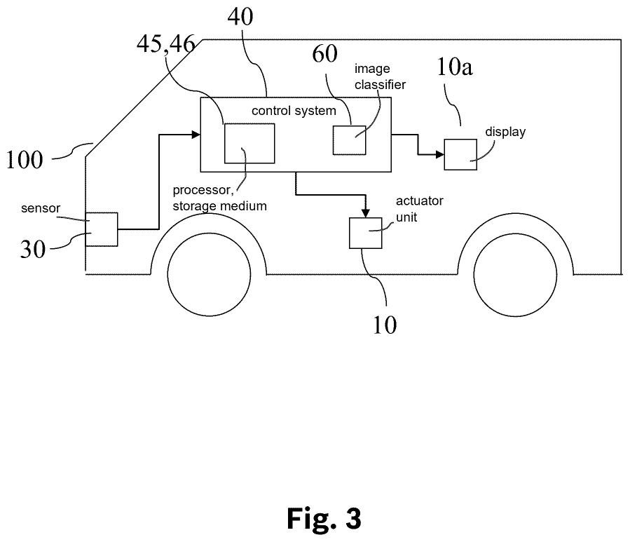

Shown in FIG. 3 is one embodiment of an actuator with a control system 40. Actuator and its environment will be jointly called actuator system. At preferably evenly spaced distances, a sensor 30 senses a condition of the actuator system. The sensor 30 may comprise several sensors. Preferably, sensor 30 is an optical sensor that takes images of the environment. An output signal S of sensor 30 (or, in case the sensor 30 comprises a plurality of sensors, an output signal S for each of the sensors) which encodes the sensed condition is transmitted to the control system 40.

Thereby, control system 40 receives a stream of sensor signals S. It then computes a series of actuator control commands A depending on the stream of sensor signals S, which are then transmitted to actuator unit 10 that converts the control commands A into mechanical movements or changes in physical quantities. For example, the actuator unit 10 may convert the control command A into an electric, hydraulic, pneumatic, thermal, magnetic and/or mechanical movement or change. Specific yet non-limiting examples include electrical motors, electroactive polymers, hydraulic cylinders, piezoelectric actuators, pneumatic actuators, servomechanisms, solenoids, stepper motors, etc.

Control system 40 receives the stream of sensor signals S of sensor 30 in an optional receiving unit. Receiving unit transforms the sensor signals S into input signals x. Alternatively, in case of no receiving unit, each sensor signal S may directly be taken as an input signal x. Input signal x may, for example, be given as an excerpt from sensor signal S. Alternatively, sensor signal S may be processed to yield input signal x. Input signal x comprises image data corresponding to an image recorded by sensor 30. In other words, input signal x is provided in accordance with sensor signal S.

Input signal x is then passed on to the image classifier 60, which may, for example, be given by an artificial neural network.

Classifier 60 is parametrized by parameters □, which are stored in and provided by parameter storage St₁.

Classifier 60 determines output signals y from input signals x. The output signal y comprises information that assigns one or more labels to the input signal x. Output signals y are transmitted to an optional conversion unit, which converts the output signals y into the control commands A. Actuator control commands A are then transmitted to actuator unit 10 for controlling actuator unit 10 accordingly. Alternatively, output signals y may directly be taken as control commands A.

Actuator unit 10 receives actuator control commands A, is controlled accordingly and carries out an action corresponding to actuator control commands A. Actuator unit 10 may comprise a control logic which transforms actuator control command A into a further control command, which is then used to control actuator 10.

In further embodiments, control system 40 may comprise sensor 30. In even further embodiments, control system 40 alternatively or additionally may comprise actuator 10.

Furthermore, control system 40 may comprise a processor 45 (or a plurality of processors) and at least one machine-readable storage medium 46 on which instructions are stored which, if carried out, cause control system 40 to carry out a method according to one aspect of the present invention.

In a preferred embodiment of FIG. 3, the control system 40 is used to control the actuator, which is an at least partially autonomous robot, e.g. an at least partially autonomous vehicle 100.

Sensor 30 may comprise one or more video sensors and/or one or more radar sensors and/or one or more ultrasonic sensors and/or one or more LiDAR sensors and or one or more position sensors (like e.g. GPS). Some or all of these sensors are preferably but not necessarily integrated in vehicle 100.

Alternatively or additionally sensor 30 may comprise an information system for determining a state of the actuator system. One example for such an information system is a weather information system which determines a present or future state of the weather in environment.

For example, using input signal x, the classifier 60 may for example detect objects in the vicinity of the at least partially autonomous robot. Output signal y may comprise an information which characterizes where objects are located in the vicinity of the at least partially autonomous robot. Control command A may then be determined in accordance with this information, for example to avoid collisions with said detected objects.

Actuator unit 10, which is preferably integrated in vehicle 100, may be given by a brake, a propulsion system, an engine, a drivetrain, or a steering of vehicle 100. Actuator control commands A may be determined such that actuator (or actuators) unit 10 is/are controlled such that vehicle 100 avoids collisions with said detected objects. Detected objects may also be classified according to what the classifier 60 deems them most likely to be, e.g. pedestrians or trees, and actuator control commands A may be determined depending on the classification.

In further embodiments, the at least partially autonomous robot may be given by another mobile robot (not shown), which may, for example, move by flying, swimming, diving or stepping. The mobile robot may, inter alia, be an at least partially autonomous lawn mower, or an at least partially autonomous cleaning robot. In all of the above embodiments, actuator command control A may be determined such that propulsion unit and/or steering and/or brake of the mobile robot are controlled such that the mobile robot may avoid collisions with said identified objects.

In a further embodiment, the at least partially autonomous robot may be given by a gardening robot (not shown), which uses sensor 30, preferably an optical sensor, to determine a state of plants in the environment 20. Actuator unit 10 may be a nozzle for spraying chemicals. Depending on an identified species and/or an identified state of the plants, an actuator control command A may be determined to cause actuator unit 10 to spray the plants with a suitable quantity of suitable chemicals.

In even further embodiments, the at least partially autonomous robot may be given by a domestic appliance (not shown), like e.g. a washing machine, a stove, an oven, a microwave, or a dishwasher. Sensor 30, e.g. an optical sensor, may detect a state of an object which is to undergo processing by the household appliance. For example, in the case of the domestic appliance being a washing machine, sensor 30 may detect a state of the laundry inside the washing machine. Actuator control signal A may then be determined depending on a detected material of the laundry.

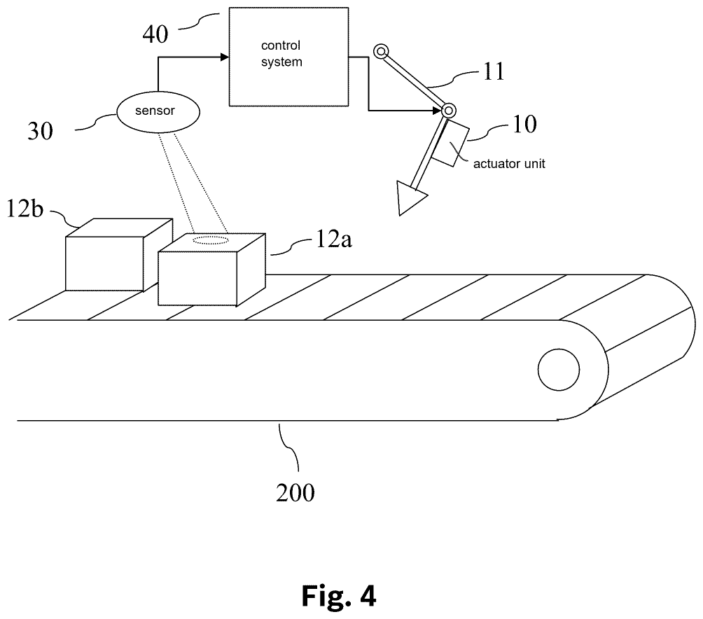

Shown in FIG. 4 is an embodiment in which control system 40 is used to control a manufacturing machine 11, e.g. a solder mounter, punch cutter, a cutter or a gun drill) of a manufacturing system 200, e.g. as part of a production line. The control system 40 controls an actuator unit 10 which in turn control the manufacturing machine 11.

Sensor 30 may be given by an optical sensor which captures properties of e.g. a manufactured product 12. Classifier 60 may determine a state of the manufactured product 12 from these captured properties. Actuator unit 10 which controls manufacturing machine 11 may then be controlled depending on the determined state of the manufactured product 12 for a subsequent manufacturing step of manufactured product 12. Or, it may be envisioned that actuator unit 10 is controlled during manufacturing of a subsequent manufactured product 12 depending on the determined state of the manufactured product 12.

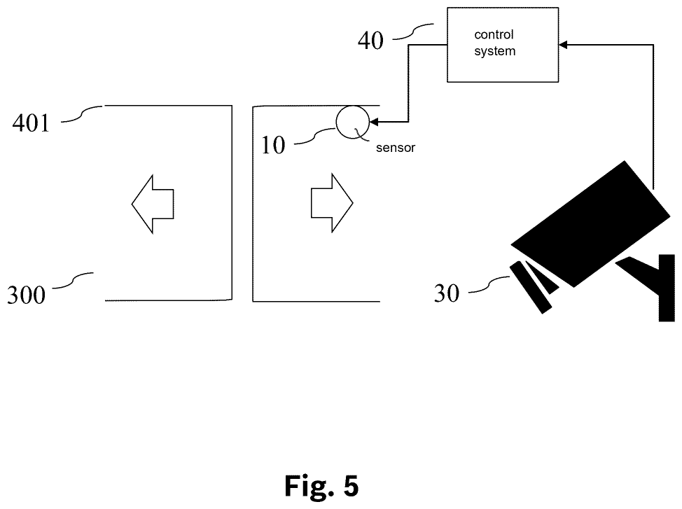

Shown in FIG. 5 is an embodiment in which control system controls an access control system 300. Access control system may be designed to physically control access. It may, for example, comprise a door 401. Sensor 30 is configured to detect a scene that is relevant for deciding whether access is to be granted or not. It may for example be an optical sensor for providing image or video data, for detecting a person's face. Classifier 60 may be configured to interpret this image or video data e.g. by matching identities with known people stored in a database, thereby determining an identity of the person. Actuator control signal A may then be determined depending on the interpretation of classifier 60, e.g. in accordance with the determined identity. Actuator unit 10 may be a lock which grants access or not depending on actuator control signal A. A non-physical, logical access control is also possible.

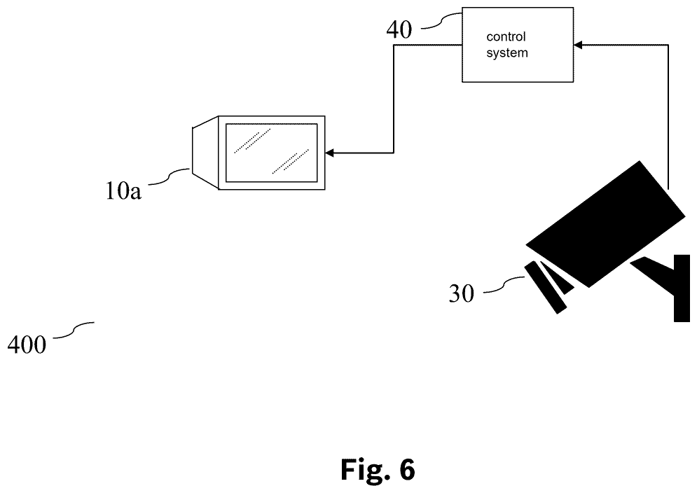

Shown in FIG. 6 is an embodiment in which control system 40 controls a surveillance system 400. This embodiment is largely identical to the embodiment shown in FIG. 5. Therefore, only the differing aspects will be described in detail. Sensor 30 is configured to detect a scene that is under surveillance. Control system does not necessarily control an actuator 10, but a display 10a. For example, the machine learning system 60 may determine a classification of a scene, e.g. whether the scene detected by optical sensor 30 is suspicious. Actuator control signal A which is transmitted to display 10a may then e.g. be configured to cause display 10a to adjust the displayed content dependent on the determined classification, e.g. to highlight an object that is deemed suspicious by machine learning system 60.

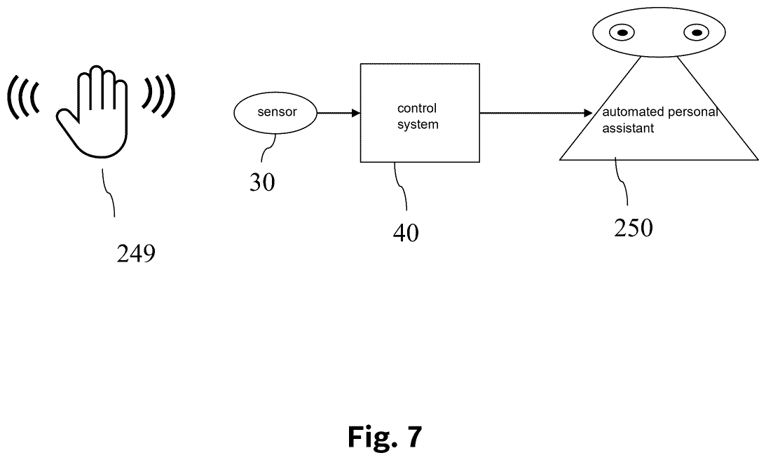

Shown in FIG. 7 is an embodiment in which control system 40 is used for controlling an automated personal assistant 250. Sensor 30 may be an optic sensor, e.g. for receiving video images of a gestures of user 249. Alternatively, sensor 30 may also be an audio sensor e.g. for receiving a voice command of user 249.

Control system 40 then determines actuator control commands A for controlling the automated personal assistant 250. The actuator control commands A are determined in accordance with sensor signal S of sensor 30. Sensor signal S is transmitted to the control system 40. For example, classifier 60 may be configured to e.g. carry out a gesture recognition algorithm to identify a gesture made by user 249. Control system 40 may then determine an actuator control command A for transmission to the automated personal assistant 250. It then transmits said actuator control command A to the automated personal assistant 250.

For example, actuator control command A may be determined in accordance with the identified user gesture recognized by classifier 60. It may then comprise information that causes the automated personal assistant 250 to retrieve information from a database and output this retrieved information in a form suitable for reception by user 249.

In further embodiments, it may be envisioned that instead of the automated personal assistant 250, control system 40 controls a domestic appliance (not shown) controlled in accordance with the identified user gesture. The domestic appliance may be a washing machine, a stove, an oven, a microwave or a dishwasher.

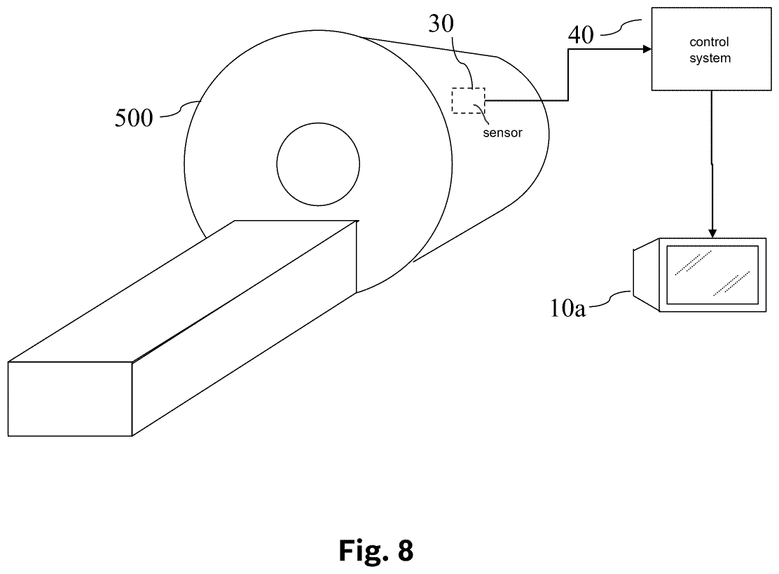

Shown in FIG. 8 is an embodiment of a control system 40 for controlling an imaging system 500, for example an MRI apparatus, x-ray imaging apparatus or ultrasonic imaging apparatus. Sensor 30 may, for example, be an imaging sensor. Machine learning system 60 may then determine a classification of all or part of the sensed image. Actuator control signal A may then be chosen in accordance with this classification, thereby controlling display 10a. For example, machine learning system 60 may interpret a region of the sensed image to be potentially anomalous. In this case, actuator control signal A may be determined to cause display 10a to display the imaging and highlighting the potentially anomalous region.

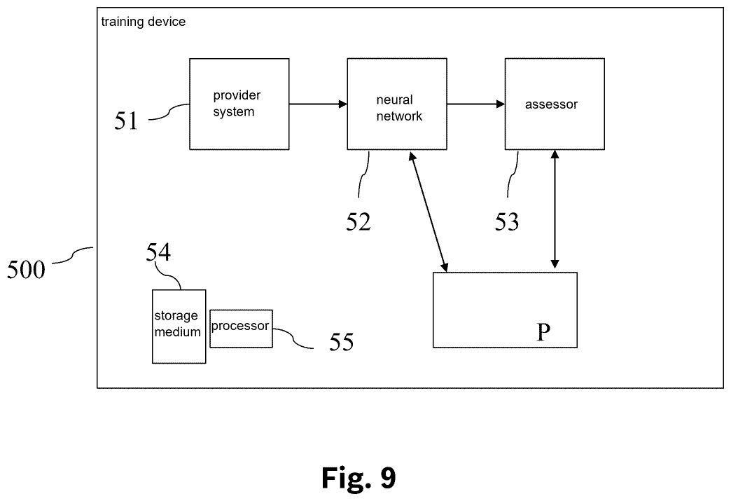

Shown in FIG. 9 is an embodiment of a training system 500. The training device 500 comprises a provider system 51, which provides input images from a training data set. Input images are fed to the neural network 52 (e.g. supermodel) to be trained, which determines output variables from them. Output variables and input images are supplied to an assessor 53, which determines acute hyper/parameters therefrom, which are transmitted to the parameter memory P, where they replace the current parameters. The assessor 53 can be arranged to execute steps S21 of the method according to FIG. 1.

The procedures executed by the training device 500 may be implemented as a computer program stored on a machine-readable storage medium 54 and executed by a processor 55.

The term “computer” covers any device for the processing of pre-defined calculation instructions. These calculation instructions can be in the form of software, or in the form of hardware, or also in a mixed form of software and hardware.

It is further understood that the procedures cannot only be completely implemented in software as described. They can also be implemented in hardware, or in a mixed form of software and hardware.

What is claimed is:

1. A computer-implemented method of neural architecture search, the method comprising the following steps:
training a supermodel with multiple searchable dimensions by sampling architectures within the searchable dimension and training the sampled architectures on labeled training data and updating weights of the supermodel by gradients of the training from the sampled architectures; and
determining Pareto-optimal submodels of the supermodel based on at least two performance metrics by iteratively carrying out the following steps:
computing outputs of a reference model for unlabeled data, wherein the reference model a largest submodel of the supermodel,
sampling a plurality of submodels from the supermodel,
computing by the submodels outputs for the unlabeled data,
computing a difference between the outputs of the reference model and the outputs of the submodels,
employing an optimization algorithm to iteratively sample and evaluate submodels based on a plurality of objectives, wherein the objectives include the differences and the sampled architectures of the submodels and performance metrics, including an accuracy and hardware latency, and
outputting the Pareto-optimal submodels based on the objectives based on the performance metrics.

2. The method according to claim 1, wherein for training the supermodel, at least two architectures are sampled for each training step, including a smallest and largest architecture based on the searchable dimensions.

3. The method according to claim 1, wherein: (i) the unlabeled data is data obtained from the same, or a related application, or (ii) synthetic data generated from a data distribution of the labeled training data.

4. The method according to claim 1, wherein the optimization algorithm is an evolutionary optimization or a Bayesian optimization.

5. The method according to claim 1, wherein the difference is a Kullback-Leibler divergence or a mean-squared error or a hard-label difference.

6. The method according to claim 1, wherein the unlabeled data has been filtered, wherein the filtering is carried out by selecting data points of the unlabeled data set with a confidence of the supermodel higher than a predefined threshold.

7. The method according to claim 1, wherein the supermodel including the submodels is trained to be a classifier for classifying sensor signals, wherein after the training, a sensor signal including data from a sensor is received, an input signal including an image which depends on the sensor signal is determined, and the input signal is fed into the classifier to obtain an output signal that characterizes a classification of the input signal.

8. The method according to claim 1, wherein a submodel from the Pareto-optimal submodels is selected based on a predefined criterion and the selected submodel is utilized for providing an actuator control signal for controlling an actuator, by determining the actuator control signal depending on an output of the submodel.

9. The method according to claim 8, wherein the actuator controls an at least partially autonomous robot or vehicle or a manufacturing machine or an access control system.

10. A non-transitory machine-readable storage medium on which is stored a computer program neural architecture search, the computer program, when executed by a processor, causing the processor to perform the following steps:
training a supermodel with multiple searchable dimensions by sampling architectures within the searchable dimension and training the sampled architectures on labeled training data and updating weights of the supermodel by gradients of the training from the sampled architectures; and
determining Pareto-optimal submodels of the supermodel based on at least two performance metrics by iteratively carrying out the following steps:
computing outputs of a reference model for unlabeled data, wherein the reference model a largest submodel of the supermodel,
sampling a plurality of submodels from the supermodel,
computing by the submodels outputs for the unlabeled data,
computing a difference between the outputs of the reference model and the outputs of the submodels,
employing an optimization algorithm to iteratively sample and evaluate submodels based on a plurality of objectives, wherein the objectives include the differences and the sampled architectures of the submodels and performance metrics, including an accuracy and hardware latency, and
outputting the Pareto-optimal submodels based on the objectives based on the performance metrics.

11. A system that is configured for a neural architecture search, the system configured to:
train a supermodel with multiple searchable dimensions by sampling architectures within the searchable dimension and training the sampled architectures on labeled training data and updating weights of the supermodel by gradients of the training from the sampled architectures; and
determine Pareto-optimal submodels of the supermodel based on at least two performance metrics by iteratively carrying out the following steps:
compute outputs of a reference model for unlabeled data, wherein the reference model a largest submodel of the supermodel,
sample a plurality of submodels from the supermodel,
compute by the submodels outputs for the unlabeled data,
compute a difference between the outputs of the reference model and the outputs of the submodels,
employ an optimization algorithm to iteratively sample and evaluate submodels based on a plurality of objectives, wherein the objectives include the differences and the sampled architectures of the submodels and performance metrics, including an accuracy and hardware latency, and
output the Pareto-optimal submodels based on the objectives based on the performance metrics.
